(19) United States
(12) Patent Application Publication
(10) Pub. No.: US 2004/0116030 A1
(43) Pub. Date: Jun. 17, 2004

(54) Protective strap for handle

(76) Inventor: Jack Wang, Taichung Hsien (TW)

Correspondence Address: BACON & THOMAS, PLLC, 625 SLATERS LANE, FOURTH FLOOR, ALEXANDRIA, VA, 22314

(21) Appl. No.: 10/320,436

(22) Filed: Dec. 17, 2002

(51) Int. Cl. B32B 27/12; B32B 9/00

(52) U.S. Cl. 442/399; 442/394; 428/102

(57) ABSTRACT

A protective strap is disclosed to include a base layer, a top layer, and a needle thread. The top layer is bonded to a top side of the base layer. The needle thread is exposed on a top side of the top layer so as to form a predetermined design by an embroidering method. The predetermined design can not only provide skidproof effect but also enhance flexibility of design alteration. Additionally, the needle thread runs into the protective strap in different deepness such that the combination between each two layers can be enhanced.

### FIELD OF THE INVENTION

The present invention relates generally to sports apparatuses, and more particularly to a protective strap for winding around the handle of a sports apparatus.

### BACKGROUND OF THE INVENTION

A conventional protective strap for winding around a handle of a sports apparatus is provided with a design at a top surface of a top layer thereof for manifesting a merchandise brand, enhancing the whole esthetic effect, slightly improving the skidproof effect, etc. The manufacturing processes of the design in accordance with the prior art are generally provided with two methods, heat-branding and printing. The heat-branding is the method that press the protective strap tightly with a heated mold having an antiphased predetermined design such that the predetermined design will be branded into the protective strap. The printing is the method that ink the printing mold having an antiphased predetermined design with a coating and press the mold tightly with the protective strap such that the predetermined design is printed to the protective strap and then process the protective strap by heat treatment for the coating adhering to the protective strap durably.

To proceed the aforementioned manufacturing processes on the protective strap, it's necessary to make the mold first. However, the more designs of the protective strap is developed, the more molds will be made, and then the more production cost in making the molds will increase. Moreover, the sooner the merchandise is promoted in the market, the sooner the merchandise will be eliminated through competition, and then the more overall cost of the merchandise will increase. Additionally, according to the purchasing experiences of the consumers, the design heat-branded into the protective strap is provided with few alternatives in color. The design printed to the protective strap is vulnerable to perspiration, sunshine, repeated and long holding, etc. so as to fade away and cause damage esthetically.

### SUMMARY OF THE INVENTION

The primary objective of the present invention is to provide a protective strap, which is adapted for use in custom-made merchandise pattern and can be manufactured and delivered to customers soon without spending time on making molds.

Another objective of the present invention is to provide a protective strap, which design on surface can be altered more flexibly than the prior art.

Still another objective of the present invention is to provide a protective strap, which is not vulnerable to perspiration and sunshine and is fairly durable in addition to having enhanced skidproof effect.

In keeping with the principle of the present invention, the foregoing objectives of the present invention are attained by the protective strap, which is formed of a base layer, a top layer, and a needle thread. The top layer is bonded to a top side of the base layer. The needle thread is exposed on a top side of the top layer so as to form a predetermined design by an embroidering method. The predetermined design can not only provide skidproof effect but also enhance the flexibility of design alteration. Additionally, the needle thread runs into the protective strap in different deepness such that the combination between each two layers can be enhanced.

### BRIEF DESCRIPTION OF THE DRAWINGS

FIG. 1 is a perspective view of a first preferred embodiment of the present invention wound around a handle of a sports apparatus;

FIG. 2 is a partial sectional view of the first preferred embodiment of the present invention;

FIG. 3 is a partial sectional view of a second preferred embodiment of the present invention;

FIG. 4 is a partial sectional view of a third preferred embodiment of the present invention;

FIG. 5 is a partial sectional view of a fourth preferred embodiment of the present invention; and

FIG. 6 is a partial sectional view of a fifth preferred embodiment of the present invention.

### DETAILED DESCRIPTION OF THE INVENTION

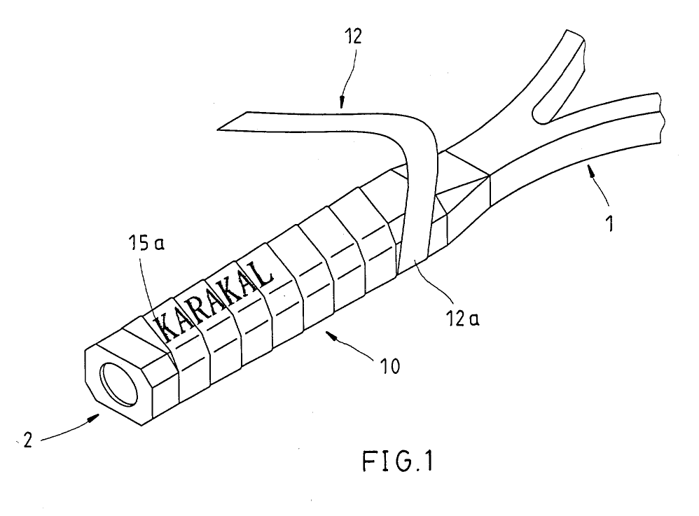

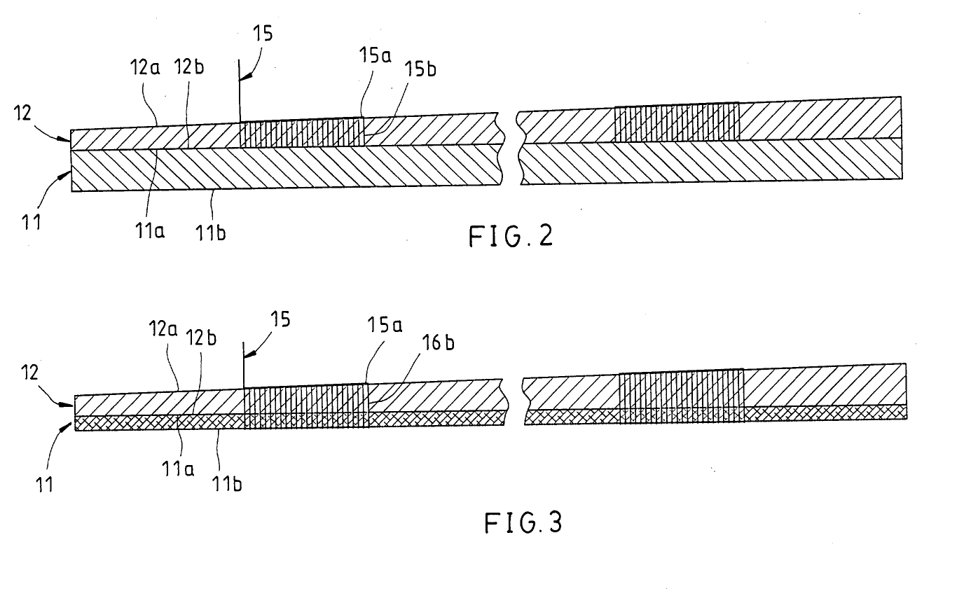

Referring to FIGS. 1 and 2, a protective strap 10 provided by a first preferred embodiment of the present invention is adapted for use in spirally winding a handle 2 of a sports apparatus 1 and then forming a gripping section on the sports apparatus. The protective strap 10 comprises a base layer 11, a top layer 12, and a needle thread 15.

The base layer 11 is made of either polyurethane (PU) or other shock-absorptive materials, such as foaming of polyvinyl chloride (PVC), foaming of ethylene-vinyl acetate copolymer, etc. The base layer 11 has a top side 11a and a bottom side 11b, which can directly or adhesively bond on the handle 2 of the sports apparatus 1. The top layer 12, which is made of a rubber material, is provided with a top side 12a and a bottom side 12b. The top side 12a of the top layer 12 has a predetermined width for a hand holding.

The present invention is characterized by the improvement in that the needle thread 15 runs through the top side 12a and the bottom side 12b of the top layer 12 from outside, and then a bobbin thread (not shown) runs through the bottom side 12b and the top side 12a to form a circuit, and again repeat the aforementioned steps. Accordingly, the needle thread 15, which runs into the top layer 12, is formed of an exposed portion 15a and a submerged portion 15b. The exposed portion 15a forms a predetermined design, such as trademark names or trademark logos or special designs, within the predetermined width of the top side 12a. After the predetermined design is completed, the top layer 12 is adhered to the top side 11a of the base layer 11 by means of an adhesive at the bottom side 12b such that the top layer 12 and the base layer 11 are adhesively adhered to each other.

Therefore, the present embodiment of the present invention includes advantages described below:

1. The design is completed by the embroidering method and no molds are necessarily made, thereby the production cost reduces. The embroidering method is adapted for the custom-made merchandise pattern.

2. The design can be easily altered by the embroidering method, thereby the present invention is more flexible in design alteration than the prior art.

3. The needle thread is not vulnerable to perspiration and sunshine such that the present invention can be kept in good condition aesthetically. The exposed portion is disposed on the top layer of the grip, thereby the grip is skidproof while holding the grip.

4. The submerged portion of the needle thread runs into the protective strap, thereby the combination of the materials between the layers can be enhanced.

Referring to FIG. 3, a second preferred embodiment different from the first preferred embodiment of the present invention lies in that the base layer 11 of the protective strap 10 is made of nonwoven cloth and the top layer 12 is made of PU and is directly coated on base layer 11. The needle thread 15 runs through the top layer 12 and the base layer 11 and then the submerged portion 15b runs through the bottom side 11b of the base layer 11 and returns to run through the top layer 12. In addition to the foregoing advantages of the first preferred embodiment, the present invention is provided with a better combinative effect than the foregoing embodiment of the present invention in light of the top layer 12 and the base layer 11 being embroidered by the needle thread 15.

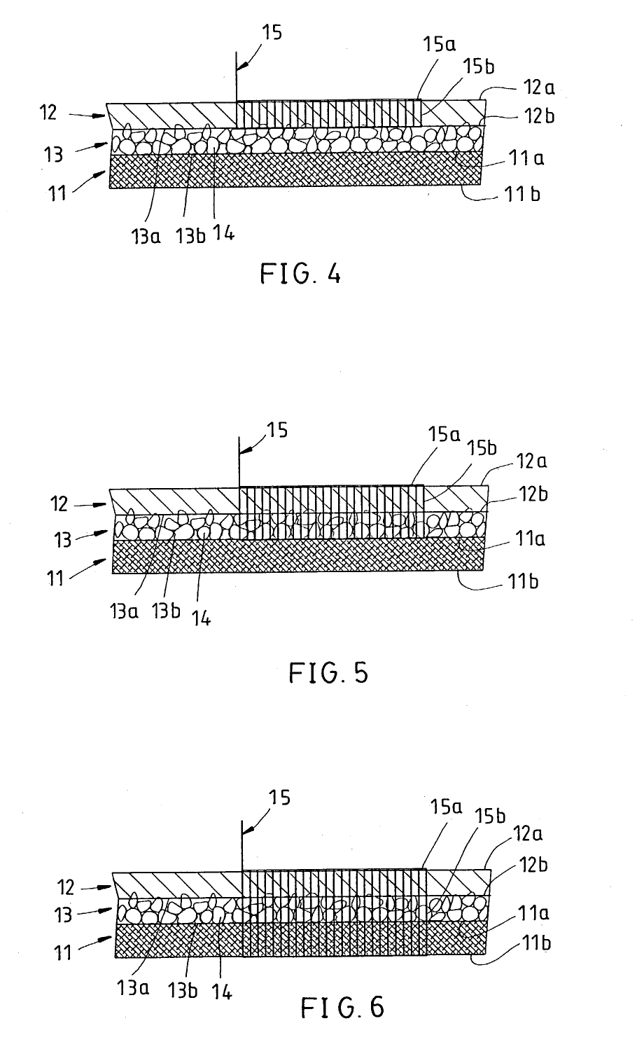

Referring to FIG. 4, a third preferred embodiment different from the foregoing preferred embodiments of the present invention lies in that the protective strap 10 is further provided with a middle layer 13, which is provided with a top side 13a and a bottom side 13b and is positioned between the base layer 11 and the top layer 12. The middle layer 13 is made of a material different from the materials of which the base layer 11 and the top layer 12 are made. In other words, the middle layer 13 can be made of a material provided with preferable effects of water-absorptivity and air permeability or resilience.

The needle thread 15 runs through the top side 12a and the bottom side 12b of the top layer 12 from outside, and then a bobbin thread (not shown) runs through the bottom side 12b and the top side 12a to form a circuit, and again repeat the aforementioned steps. Accordingly, the needle thread is, which runs into the top layer 12, is formed of an exposed portion 15a and a submerged portion 15b. The exposed portion 15a forms as a predetermined design, such as trademark names or trademark logos or special designs, within the predetermined width of the top side 12a. After the predetermined design is completed, the top layer 12 is bonded to the top side 13a of the middle layer 13 by means of an adhesive at the bottom side 12b and then the middle layer 13 is adhered to the top side 11a of the base layer 11 at the bottom side 13b thereof such that the top layer 12, the middle layer 13, and the base layer 11 are adhesively adhered to one another.

Referring to FIG. 5, a fourth preferred embodiment different from the third preferred embodiment of the present invention lies in that the needle thread 15 runs through the top layer 12 and the middle layer 13 from outside and then the submerged portion 15b runs through the bottom side 13b of the middle layer 13 and returns to run through the top layer 12. After the design is completed, the middle layer 13 is adhesively adhered to the top side 11a of the base layer 11 at the bottom side 13b thereof. In addition to the foregoing advantages of the first preferred embodiment, the present invention is provided with a better combinative effect than the foregoing embodiments of the present invention in light of the top layer 12 and the base layer 11 being embroidered by the needle thread 15.

Referring to FIG. 6, a fifth preferred embodiment different from the fourth preferred embodiment of the present invention lies in that the needle thread 15 runs through the top layer 12, the middle layer 13, and the base layer 11 from outside and then the submerged portion 15b runs through the bottom side 11b of the base layer 11 and returns to run through the top layer 12. In addition to the foregoing advantages of the first preferred embodiment, the present invention is provided with a better combinative effect than the foregoing embodiments of the present invention in light of the top layer 12, the middle layer 13, and the base layer 11 being embroidered by the needle thread 15.

What is claimed is:

1. A protective strap for winding around a handle of a sports apparatus, comprising:
a base layer having a top side and a bottom side bonded to the handle of the sports apparatus;
a top layer having a top side and a bottom side bonded to said top side of said base layer, wherein said top side of said top layer has a predetermined width; and
a needle thread running within the predetermined width of said top side of said top layer and formed of an exposed portion and a submerged portion, said exposed portion forming a predetermined design on the top side of the top layer, said submerged portion running through and disposed between at least said top side and said bottom side of said top layer.

2. The protective strap as defined in claim 1, wherein said submerged portion of said needle thread runs through said bottom side of said base layer and returns to run through said top layer.

3. The protective strap as defined in claim 1 further comprising a middle layer having a top side and a bottom side and interposed between the base layer and the top layer.

4. The protective strap as defined in claim 3, wherein said needle thread runs through said top layer and said middle layer from outside and then said submerged portion runs through said bottom side of said middle layer and returns to run through said top layer.

5. The protective strap as defined in claim 3, wherein said needle thread runs through said top layer, said middle layer, and said base layer from outside and then said submerged portion runs through said bottom side of said base layer and returns to run through said top layer.

6. The protective strap as defined in claim 1, wherein said top layer is made of rubber and said base layer is made of polyurethane (PU).

7. The protective strap as defined in claim 1, wherein said top layer is made of rubber and said base layer is made of foaming of ethylene-vinyl acetate copolymer.

8. The protective strap as defined in claim 1, wherein said top layer is made of polyurethane (PU) and said base layer is made of nonwoven cloth.

9. The protective strap as defined in claim 3, wherein said middle layer is made of a resilient material.

10. The protective strap as defined in claim 3, wherein said middle layer is made of a material provided with preferable water-absorptivity and air permeability.

11. The protective strap as defined in claim 1, wherein said submerged portion runs through said bottom side of said top layer and then a bobbin thread runs through said bottom side of said top layer and said top side of said top layer so as to form a circuit.

12. The protective strap as defined in claim 2, wherein said submerged portion runs through said bottom side of said base layer and then a bobbin thread runs through said bottom side of said base layer and said top side of said top layer so as to form a circuit.

13. The protective strap as defined in claim 4, wherein said submerged portion runs through said bottom side of said middle layer and then a bobbin thread runs through said bottom side of said middle layer and said top side of said top layer so as to form a circuit.
